(19) United States
(12) Patent Application Publication
(10) Pub. No.: US 2018/0216504 A1
(43) Pub. Date: Aug. 2, 2018

(54) ELECTROMAGNETIC LINEAR MOTOR

(71) Applicant: HDM S.R.L., Montebelluna (IT)

(72) Inventor: Paolo DE MAR, Montebelluna (IT)

(21) Appl. No.: 15/766,816

(22) PCT Filed: Oct. 12, 2016
(86) PCT No.: PCT/IB2016/056096

§ 371 Date: Apr. 8, 2018

(30) Foreign Application Priority Data
Oct. 29, 2015 (IT) 102015000066871

(51) Int. Cl. F01L 9/04; F04B 27/08; F04B 27/00; F04B 35/04; H02K 41/03

(52) U.S. Cl. CPC F01L 9/04; F04B 27/0895; F01L 2009/0423; F04B 35/045; H02K 41/031; F04B 27/005

(57) ABSTRACT

An electromagnetic linear motor is described. It comprises a tubular stator (1) having a longitudinal axis (W); and a permanently magnet (7) with poles oriented along the axis and linearly movable along said axis inside the stator (1). The stator (1) comprises at least two columns (A, B) formed by electromagnets (2), each electromagnet (2) comprising a core (U) formed by a central straight segment (4) and two end polar expansions (5) all being oriented towards the—and orthogonally to—said axis (W), The columns are circularly arranged around said the permanent magnet (7), and mutually linearly offset along said axis.

The present invention relates to an electromagnetic linear motor. The motor can be used to move the movable parts of various apparatuses, e.g. a reciprocating linear compressor, a linear actuator, or a solenoid valve.

As an example application we refer to the field of compressors, in which numerous types are known: piston-operated, screw-operated, lobed, with propellers, centrifugal etc., for the most part moved by rotary motors.

There are other systems of linear compressors mostly applicable in refrigeration systems. This sector may be improved by the introduction of a suitable linear motor.

The main object of the present invention is to propose an electromagnetic linear motor, in particular to produce linear compressors, actuators, and solenoid valves. Thanks to the linear motor one can e.g. make a linear reciprocating compressor with double efficiency compared to the current reciprocating compressors driven by rotary motors; in general the motor is integrable into systems that require compression of a fluid, into compression systems, into refrigerant systems, heat pumps or volume compressors for internal combustion engines.

With the electromagnetic linear motor one is able to accomplish:
a compact, modular, silent alternative linear compressor able, at the same time, to produce high flow rates and prevalence, and/or hydraulic head;
a linear reciprocating compressor that has reduced manufacturing complexity and a relatively easy tune-up;

The same advantages are shared in the production of linear actuators and/or solenoid valves, in particularly for distribution valves, with fully-electronic control, in reciprocating endothermic engines.

A linear motor and its advantageous variants are defined in the appended claims, while features and advantages of the present invention are illustrated by the following description of some embodiments, illustrated with reference to the following figures:

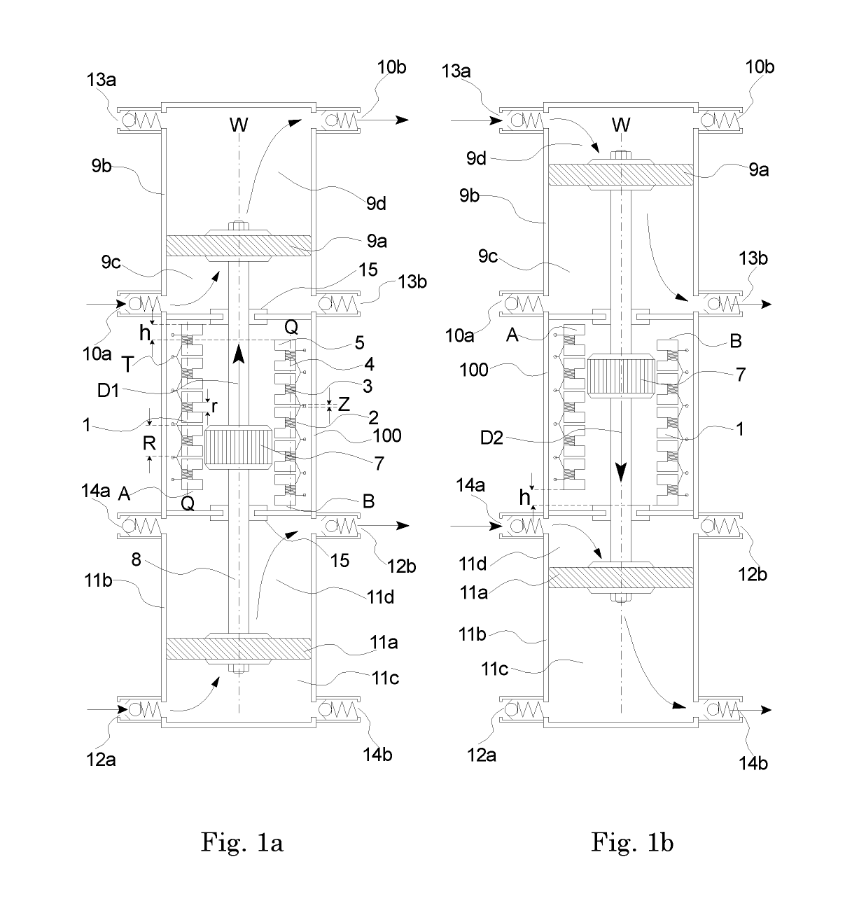

FIGS. 1a and 1b show a sectional view of the linear motor configured to drive a compressor, respectively in two different operating phases;

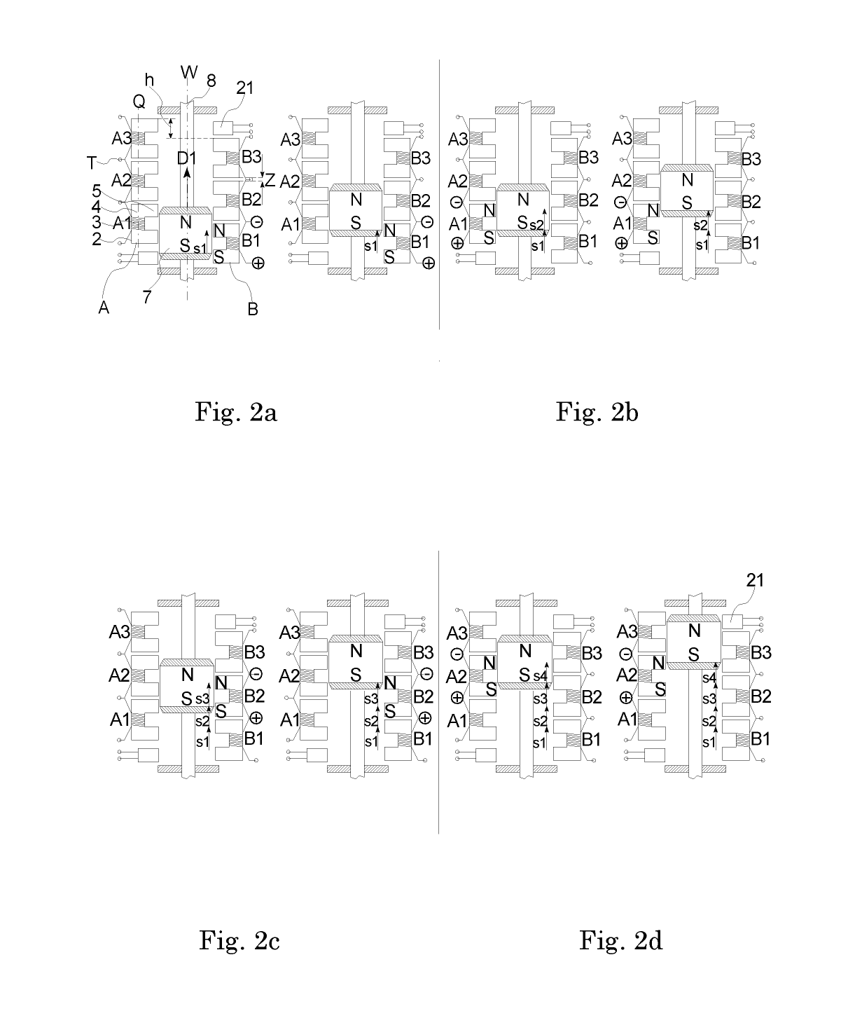

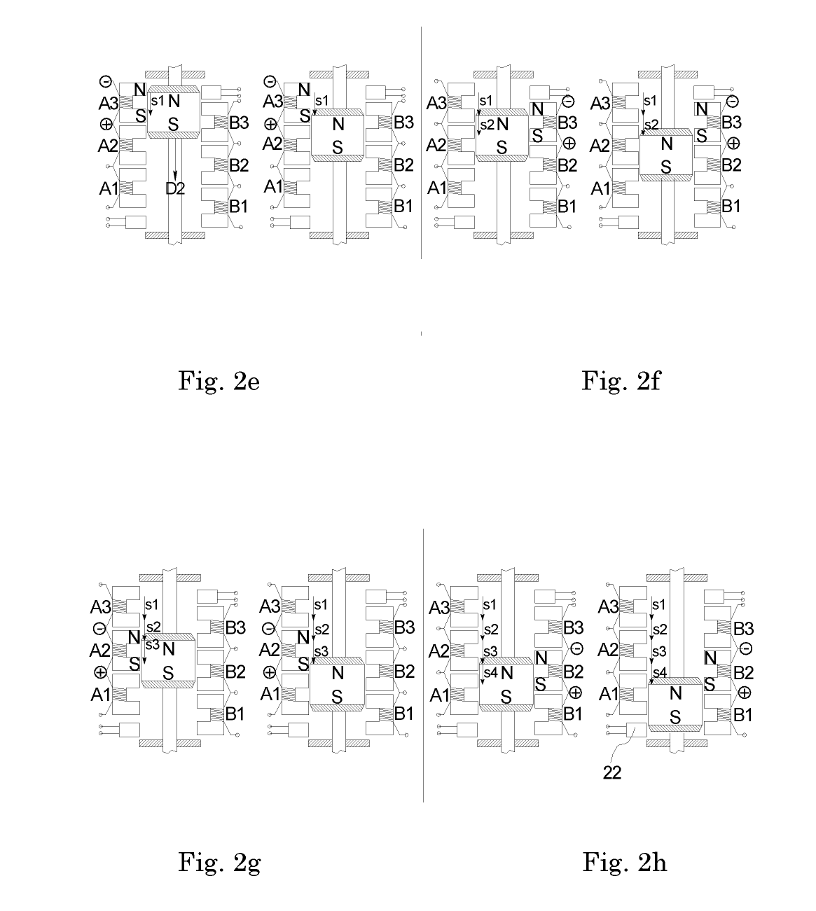

FIGS. 2a-2h show schematic views in succession representative of a complete working cycle of the linear motor with single permanent magnet;

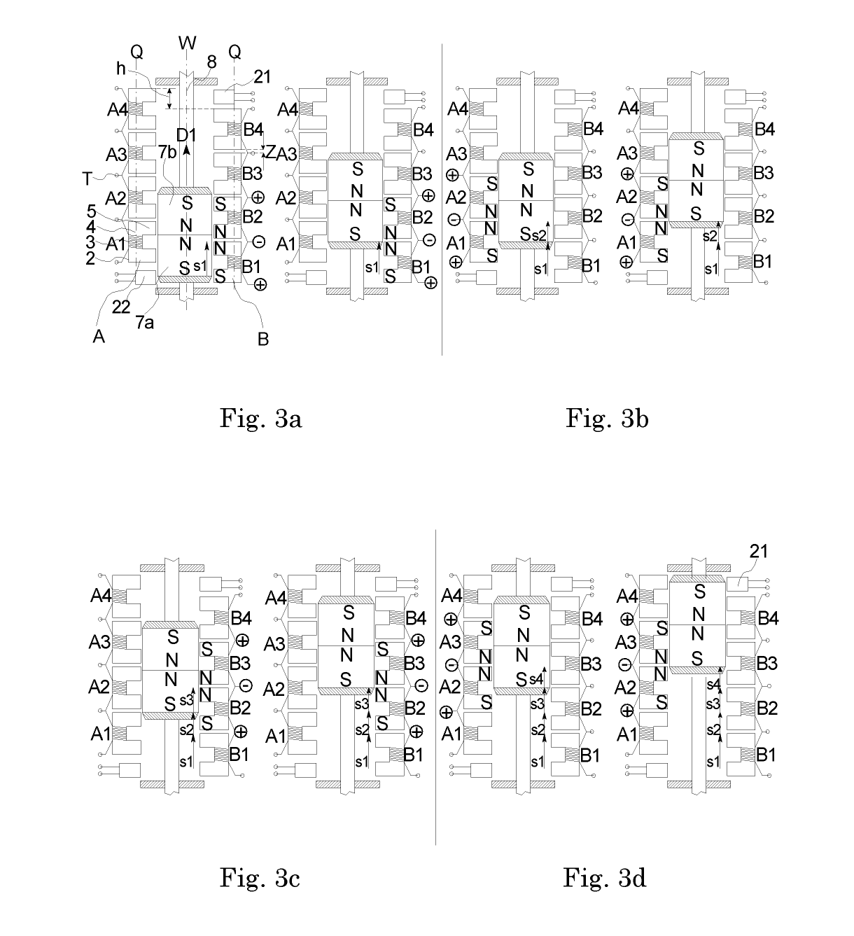

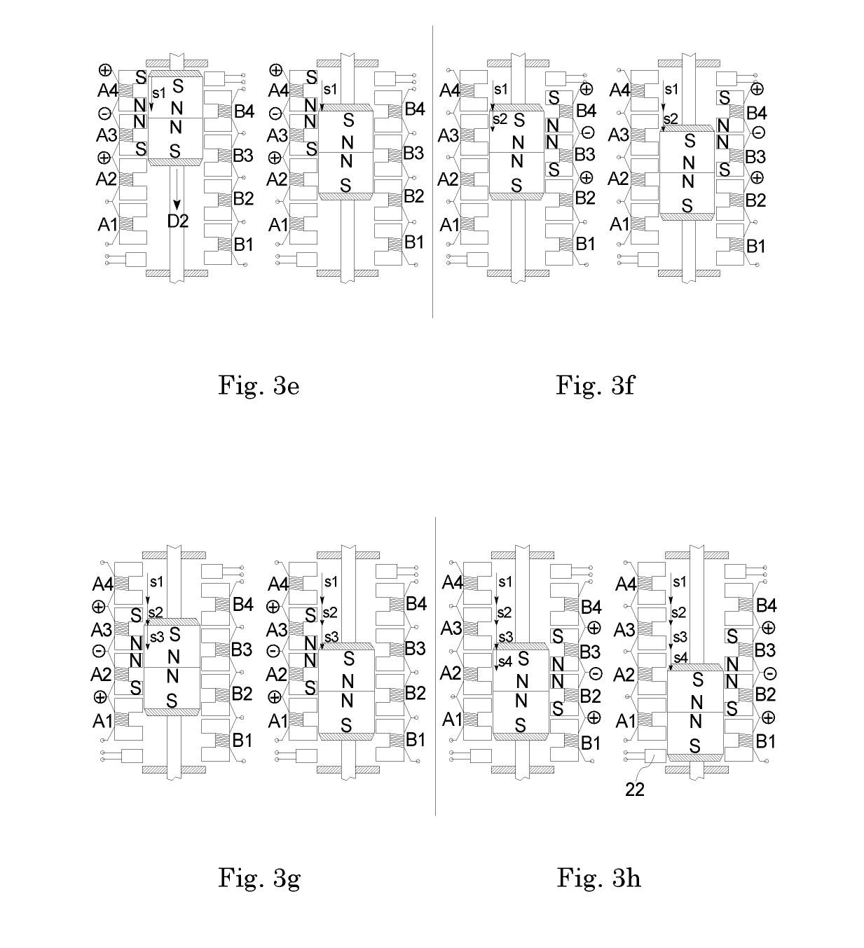

FIGS. 3a-3h show schematic views in succession representative of a full working cycle of the linear motor with a double permanent magnet;

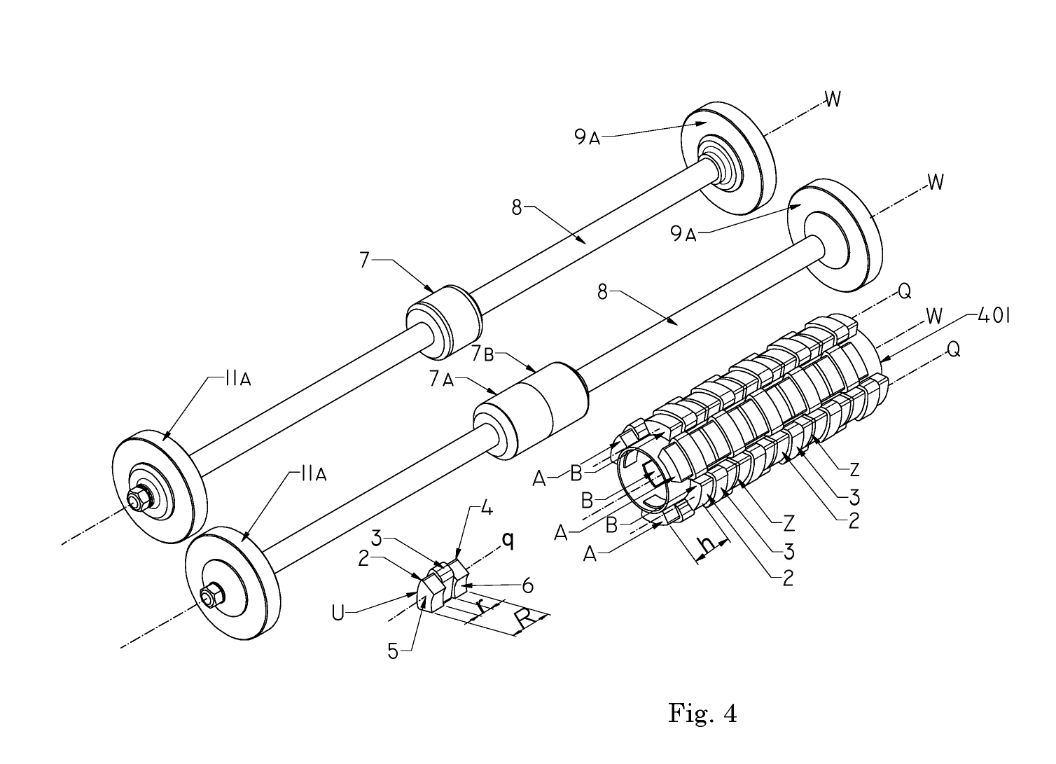

FIG. 4 shows a perspective view of some components of the linear motor of FIGS. 1a and 1b;

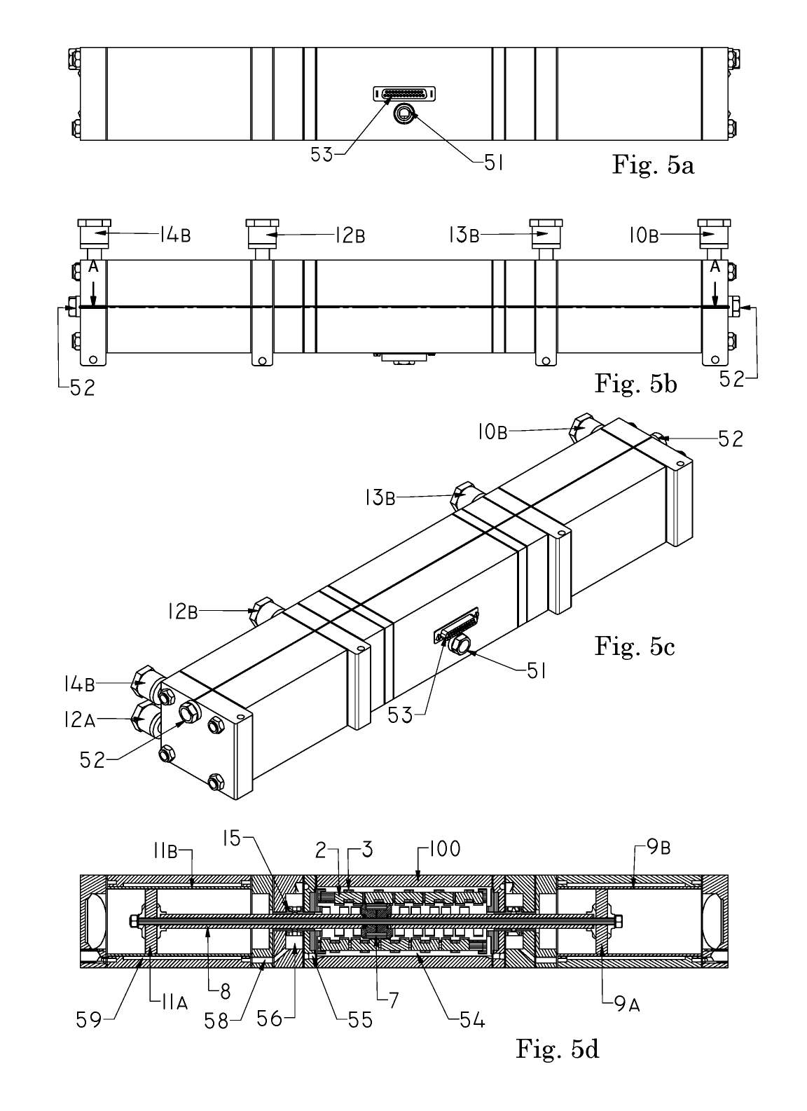

FIGS. 5a-5c show a front, above and perspective view, respectively, of a compressor obtainable according to the present invention;

FIG. 5d shows a sectional view taken along the plane A-A of FIG. 5b;

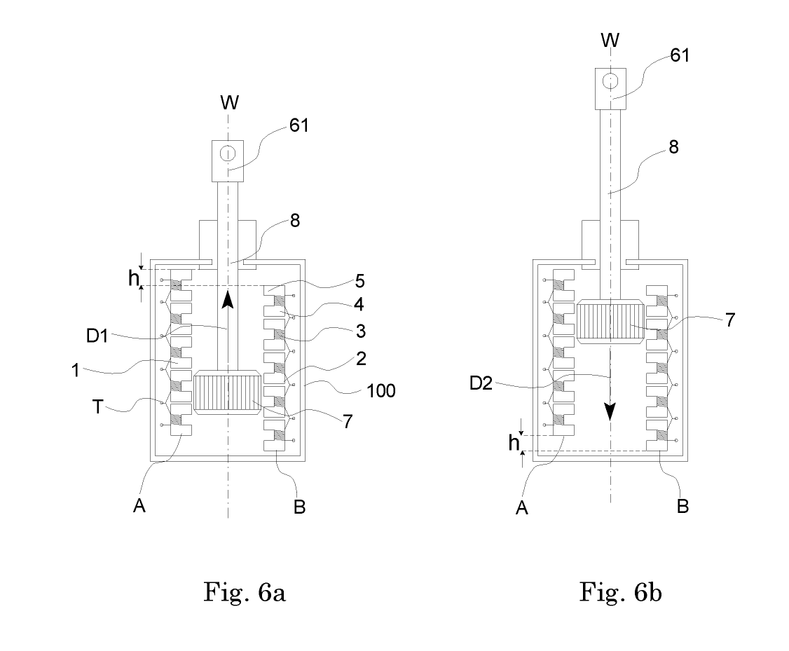

FIGS. 6a-6b show a sectional view of the linear motor configured as actuator;

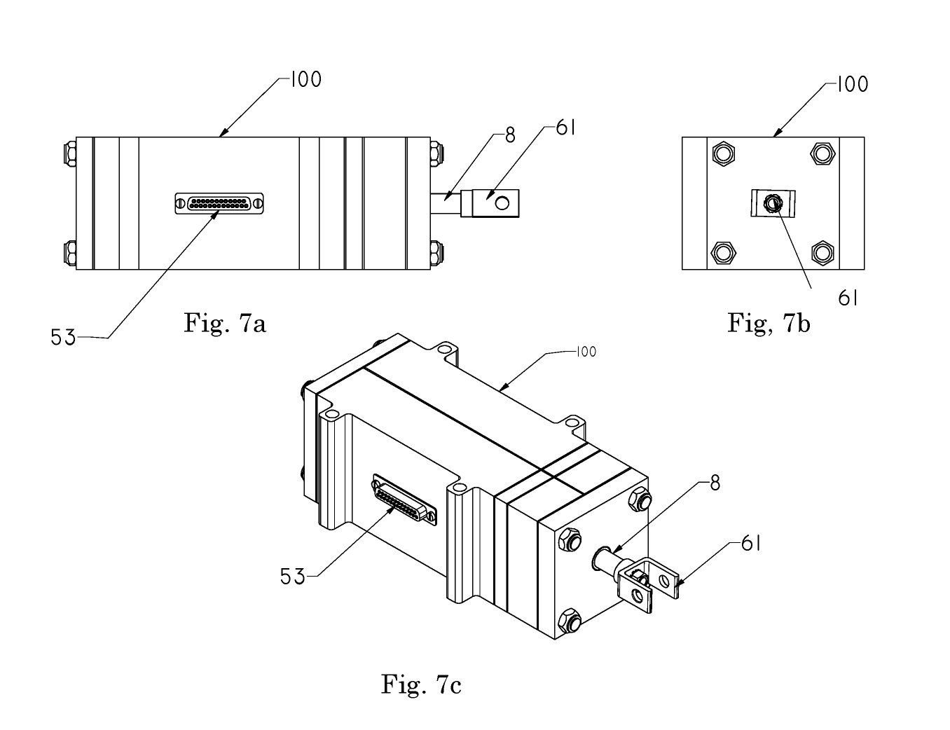

FIGS. 7a-7c show a side, front and perspective view of an actuator driven by the linear motor;

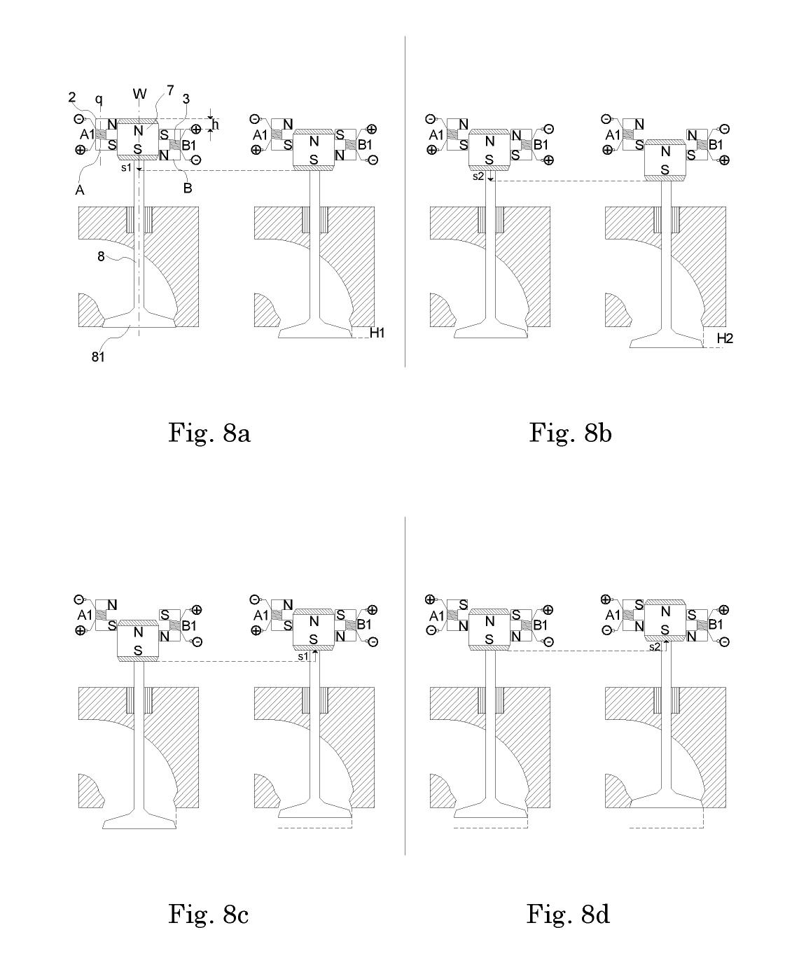

FIGS. 8a-8d schematically show the operation of a distribution valve driven by the linear motor with a permanent magnet;

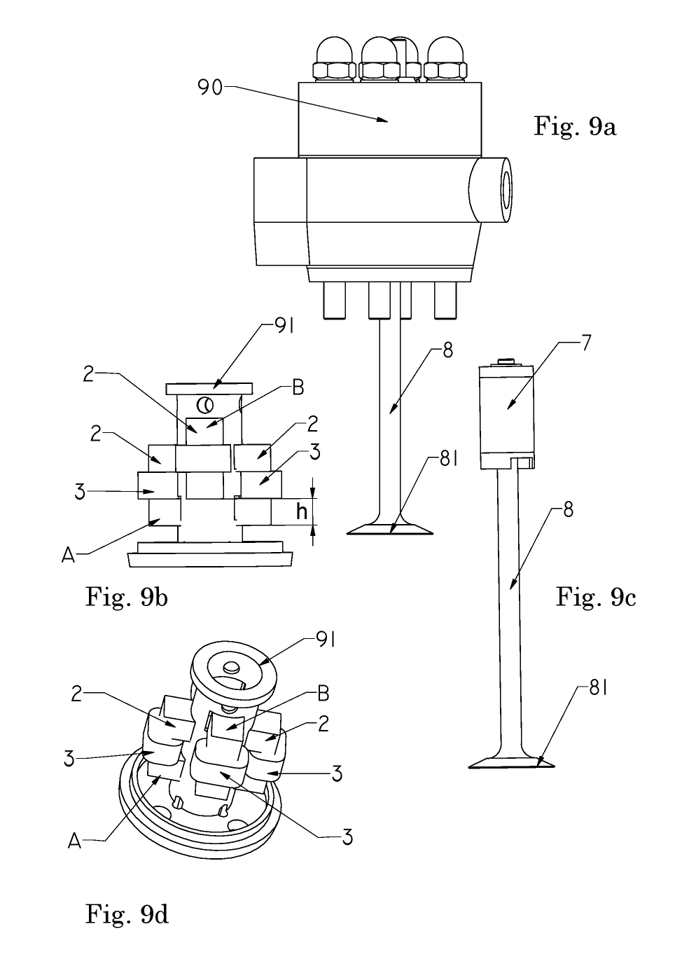

FIGS. 9a, 9b, 9d show a side, front and perspective view of an embodiment of distribution valve driven by the linear motor;

FIG. 9c shows a front view of a component of the embodiment in FIG. 9a;

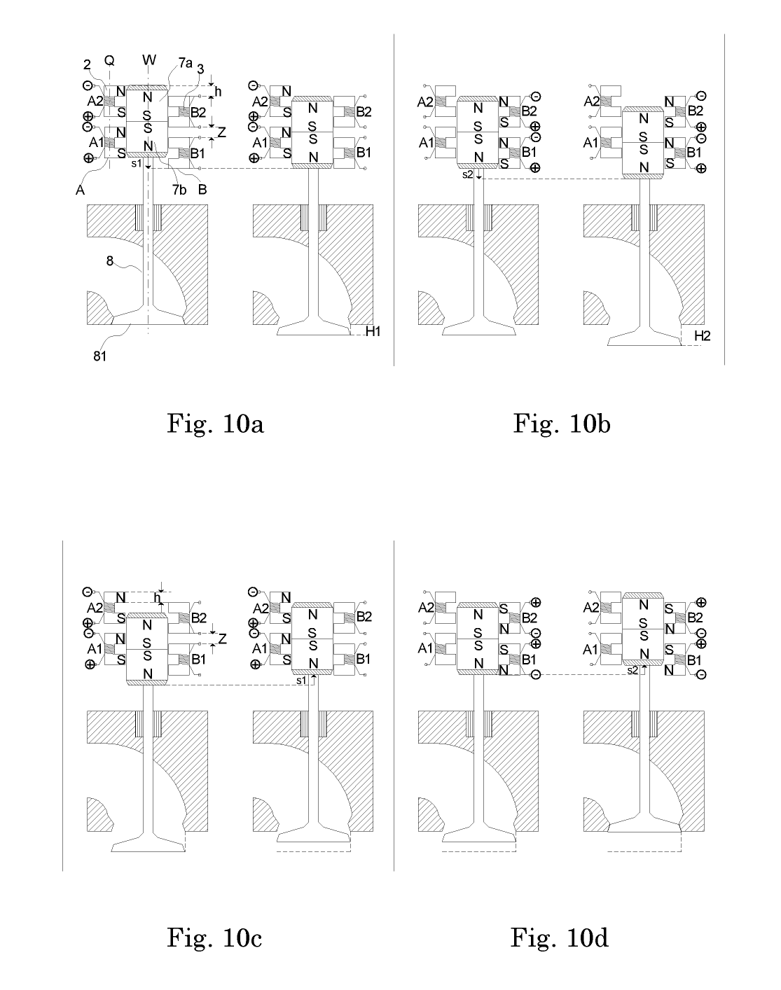

FIGS. 10a-10d schematically show the operation of a distribution valve driven by a linear motor with two permanent magnets;

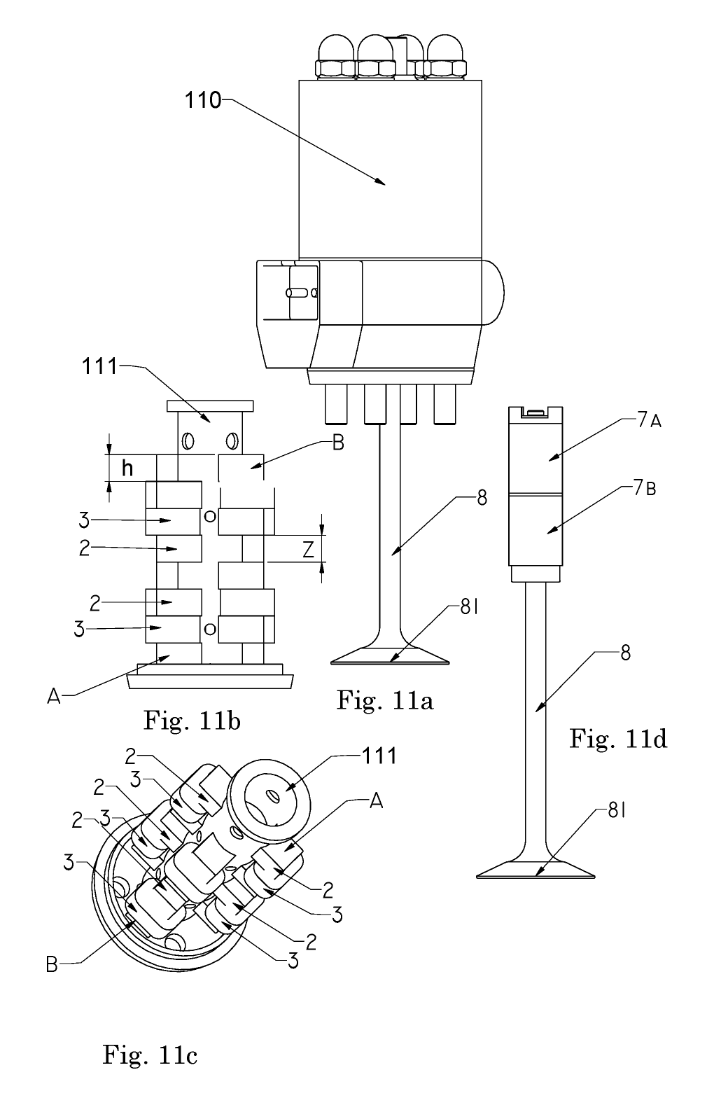

FIGS. 11a, 11 b, 11c show a side, front and perspective view of an embodiment of a distribution valve operated by the linear motor;

FIG. 11d shows a front view of a component of the embodiment in FIG. 11a.

In the following, identical numbers indicate identical or similar parts; and the letters N and S indicate respectively North and South magnetic poles.

As a first application of the motor we refer to a compressor.

In FIG. 1a there is shown in cross-section a compressor in a first phase of an operation cycle. The compressor comprises the electromagnetic linear motor, which comprises a stator 1 constituted by a plurality of electromagnets 2 (see also FIG. 2).

Each electromagnet 2 comprises a core U on which are wound reels or windings 3. In particular, the core U comprises a central linear segment 4, with an axis q, from the ends of which extend orthogonally to said axis q two polar expansions 5 parallel to each other. The central linear segment and the two polar expansions 5 together form a ferromagnetic core in the shape of a “C” or a “U” or a “horseshoe”. Preferably, the polar expansions 5 are recessed in the shape of an arc 6, in the part distal to said axis q, with a radius slightly greater than the diameter 10 of the permanent magnet 7 that they will skim. The longitudinal dimensions of the ferromagnetic core are determined by the length R between the extreme edges of the polar expansions and by the distance r between the inner edges of the polar expansions (FIG. 4).

The electromagnets 2 are stacked to constitute a cylindrical chamber 100 with a longitudinal axis W, so that the stator 1 has a generally tubular shape. Preferably the electromagnets 2 are applied on the side walls of a hollow cylinder 401 (FIG. 4) and provided with through-holes in which the expansions 5 are inserted.

Within the stator 1 is placed a cylindrical permanent magnetic component 7 which is mounted to slide along the axis W. The stator 1 surrounds the permanent magnet 7 with the electromagnets 2, whose magnetic poles, i.e. the polar expansions 5, are arranged radially and orthogonally with respect to said component 7 and consequently extend radially and orthogonally relative to the axis W. The arcuate shape of the expansions 5 facilitates their symmetric distribution about, and to skim, the permanent magnet 7 (FIG. 4).

The electromagnets 2 are linearly packed and stacked with their axes q aligned to form columns A, B with axis Q, so that the expansions 5 of a column A are offset along the axis W compared to those of another column B. Each electromagnet 2 is arranged linearly with another electromagnet 2, with coincident axes q, so that the respective expansions 5, the poles, form along the columns a longitudinal sequence parallel to the axis W. The poles of the permanent magnet 7 are oriented along the axis W.

In other words, there are columns of electromagnets 2 placed radially side by side, arranged around the permanent magnet 7, and each column with axis Q parallel to the axis W (axis of the stator 1, and thus longitudinal axis of the chamber 100). The electromagnets 2 when powered generate respective magnetic poles that are placed in a row radial and parallel to the axis W and, consequently, to the permanent magnetic component 7 which they have to skim. The magnetic field closes from an N pole to an S pole hitting the permanent magnetic component 7 and the axis W.

In particular, the linear motor comprises at least a first plurality of electromagnets 2 with related coils 3 with the cores' axes q linearly arranged to form one of the columns A with axis Q. In the example shown (FIG. 1, 4) there are indicated five electromagnets 2, and at least a second plurality of electromagnets 2, with relative coils 3, with the core axes q placed lined up to form one of the columns B with axis Q. The bases of the columns A, B are offset from each other by a distance h in a direction parallel to the axis W.

The electromagnets 2 constituting the columns are linearly arranged with coincident axes q to constitute an axis Q parallel to the axis W, with a spacing Z between the poles of each adjacent electromagnet. The spacing Z may vary according to design and operational requirements.

The electromagnets 2 are preferably identical to each other, regardless of the column they belong to.

The electromagnets 2 of a column A are arranged staggered along the axis W, with respect to the electromagnets 2 of an adjacent column B, by a distance h. The order of magnitude of the offset h between the columns A and B may vary according to design and operational requirements.

In the example illustrated in FIG. 4 there are visible a total of three columns A and three columns B, five electromagnets 2 with axis Q, arranged offset to each other by the distance h—in an alternating manner parallelly to the axis W.

The electromagnets 2 of a first column A are electrically powered and biased in sequence, simultaneously or alternately to the electromagnets 2 of a second column B staggered with respect to the first by the distance h.

In the following description, any spatial reference will refer to the spatial arrangement as shown in the accompanying figures.

In FIG. 1a is shown a first phase is shown of a complete compression cycle of a fluid. By suitably biasing the electromagnets 2 of the various columns A and B, as will be better described below, one determines the displacement of the permanent magnet 7 to the direction indicated by arrow D1 along the axis W.

The permanent magnet 7 is keyed on a stem 8 connected at the two ends respectively to a first plunger 9a and a second plunger 11a placed, in this case, symmetrically with respect to the permanent magnet 7; in the example each plunger 9a, 11 a is placed at a respective end of the stem 8.

In particular the first plunger 9a is inserted airtightly in a first cylinder 9b, and the second plunger 11a is inserted watertightly in a second cylinder 11b.

When the permanent magnet 7 moves upwards, moving in the direction of arrow D1, a vacuum is created in the lower part 9c of the first cylinder 9b, below the first plunger 9a, leading to a depression and consequent suction of fluid through a first suction opening 10a intercepted by a non-return suction valve.

At the same time, the fluid aspirated in the previous cycle and contained in the top part 9d of the first cylinder 9b, above the first plunger 9a, is compressed and pushed through a first delivery opening 10b, intercepted by a non-return delivery valve which communicates with a storage tank under pressure.

Symmetrically, the second plunger 11a, dragged by the displacement of the permanent magnet 7, moves in the direction of arrow D1 causing a depression in the bottom part 11c of the second cylinder 11b, under the second plunger 11a, leading to a suction of fluid through a second suction opening 12a intercepted by a non-return-suction valve.

At the same time the fluid previously sucked and contained in the upper part 11d of the second cylinder 11b, above the second piston 11a, is compressed and pushed through a second delivery opening 12b, intercepted by a non-return delivery valve that communicates with the storage tank under pressure.

In FIG. 1b a second phase of the complete cycle is shown, that of the return. Here by appropriately biasing the electromagnets 2 of the various columns A and B the downwards displacement of the permanent magnet 7 is determined, to the direction indicated by the arrow D2.

The first plunger 94 by moving to the direction of arrow D2 determines a depression in the top part 9d of the first cylinder 9b, resulting in a suction of fluid through a third suction opening 13a intercepted by a non-return suction valve.

The previously-sucked fluid and contained in the lower part 9c of the first cylinder 9b is compressed and pushed through a third discharge opening 13b intercepted by a non-return delivery valve that communicates with the storage tank under pressure.

Symmetrically, the second plunger 11a, dragged by the displacement of the permanent magnet 7, moves to the arrow direction D2 causing a depression in the top part 11d of the second cylinder 11b, resulting in a suction of fluid through a fourth suction opening 14a intercepted by a non-return suction valve.

At the same time the fluid previously sucked and contained in the lower part 11c of the second cylinder 11b is compressed and pushed through a fourth non-return delivery valve 14b that communicates with the storage tank under pressure.

For each complete cycle, a displacement upwards in the direction D1 and a displacement downwards in the direction D2, the compressor compresses a volume of fluid equal to the volume of one of the two cylinders 9b, 11b less the volume of a plunger 9a, 11a multiplied by four:

V_{cycle}=(V_{cylinder}−V_{plunger})*4, where V stands for volume (e.g. in m³).

This taking into account that the first and the second cylinder 9b, 11b have an identical volume, and that the first and the second plunger 9a, 11a have an identical volume.

A small volume occupied by the stem 8 must be subtracted from V_{cycle}.

The capacity of the compressor, usually expressed in cubic meters per minute, will be determined by V_{cycle} times the frequency of cycles per second multiplied by sixty:

Capacity(m³/min)=(V_{cycle}*cycles/sec)*60

A compressor as described and configured with two pistons is able to compress a volume of fluid equal to that compressed by a reciprocating compressor, moved by a rotary motor, with four pistons. The number of pistons being equal and with the same size, it can compress a double quantity of fluid.

In FIG. 2a the start of the operating cycle of the electromagnetic linear motor is schematically represented, which moves the compressor, in which two columns A and B are highlighted, constituted by three electromagnets 2 and relative coils 3 spaced by spacing Z. Such columns are alternately offset from each other by the distance h.

For sake of simplicity, there are indicated columns A and B consisting of three electromagnets 2.

Despite the electromagnets 2 being power-supplied individually, in order to reduce the number of connections necessary for the motor's operation, the coils 3 of the electromagnets 2 of each column are preferably connected in series with each other. The power-supply of the individual coils takes place by applying voltage to the terminals T of the coils 3. It can be observed that the series connection allows to power-supply three electromagnets with only four terminals instead of six.

In this example the movable magnetic component is represented by a single cylindrical permanent magnet 7.

FIG. 2a represents the beginning of the cycle in the direction D1, upwards in the figure, that for sake of simplicity we call “forward”.

The electromagnet B1, of column B, is electrically powered with direct or pulsed DC current, with a polarity such as to magnetize it with a magnetic field having the same polar orientation of the permanent magnet 7. To obtain this object, for example an electronic control unit (not shown) is used connected to the windings 3. We will denote schematically the biasing mode with the symbols+B1− to indicate the positive pole applied to the lower terminal T of the coil and the negative pole to the upper terminal.

In this way, the S pole of the electromagnet B1 and the S pole of the permanent magnet repel; similarly, the N pole of the electromagnet and the N pole of the permanent magnet repel. Instead the N poles of opposite sign of the upper pole of the electromagnet and the lower S pole of the permanent magnet 7 attract.

The permanent magnet 7 at the end of the previous cycle is moved upwards relative to the electromagnet B1. The permanent magnet 7 receives a double thrust by the poles S-S and N-N and an attraction by the S-N poles upwards in the direction D1.

The permanent magnet 7 has preferably a length along the axis W equal to the distance that there is between the opposite edges of the polar extensions 5 measured parallelly to the same axis W or distance R.

The thrust, and therefore the force to compress the fluid, is proportional to the size of the electromagnets 3, the characteristics of the windings of the coils, the diameter of the permanent magnet 5, the applied voltage and resulting adsorbed amperage.

After a time in the order of milliseconds, see the right side of FIG. 2a, completed the shift s1, there is determined the new position of the permanent magnet 7 resulting by the attraction between the S pole of the permanent magnet 7 and the N pole of electromagnet B1.

After this first period of time, see FIG. 2b, the electronic control unit, set to the linear motor's control, suspends power to the reel B1 and simultaneously powers the electromagnet A1 biasing it +A1−, as in the previous phase, in the same the direction of the permanent magnet 7. The latter is now slightly offset from the electromagnet A1, and is further forced to move in the direction D1 coming in a new position shown at the right of FIG. 2b in which the S pole of the permanent magnet 7, attracted by N pole of electromagnet A1, aligns with the latter having made a shift s2.

In FIGS. 2c and 2d there are indicated the successive displacements s3 and s4, and relative biasings, that occur with similar mode when polarizing alternatively the electromagnets 2 of columns A and B.

In FIG. 2d is represented the last displacement s4 which completes half of the cycle.

Although the linear motor can work simply by setting a timer on and alternating the power supply of the various electromagnets, it is preferable to insert two electromagnetic or photoelectric sensors 21 and 22 to signal when the permanent magnet 7 reaches the end of the stator 1 as shown in FIGS. 2d and 2h.

FIG. 2e shows the beginning of half return-cycle in the back direction D2, opposite to the direction D1. The coil A3 in column A is biased and, similarly to the forward cycle, the power supply of the electromagnets of the column A and B is alternated arriving at the end of the cycle, the latter being represented in FIG. 2h.

With the sensor 22 the control unit detects the completion of the cycle and starts a new cycle as in FIG. 2a.

The operation described so far may take place by appropriately timing the biasing sequence of the coils of the electromagnets 2 by the control unit. In the calibration phase of the system one must determine at what interval such sequence should take place and what voltage to use according to the operating pressure of the compressor.

The control unit preferably comprises means for varying the voltage and frequency of the power-supply of the windings on the basis of variable operating needs. From FIG. 3a to FIG. 3h there is shown a variant of the linear motor with a stator identical to that reported in FIGS. 2a-2h, but wherein the movable permanent magnetic component is made no longer by one but by two permanent magnets 7a, 7b. The magnets 7a, 7b are stacked and juxtaposed by the poles of equal polarity (in the illustrated example the poles N-N are close together).

The stator 1 is equal to the first variant with the columns A and B offset by a distance h from each other. In this case the mode changes with which the biasing of the electromagnets 3 takes place by means of the central unit since, instead of biasing only one magnet at a time, two adjacent magnets for each column are biased at a time, that is, a pair of electromagnets at a time.

In FIG. 3a there is biased the pair of electromagnets B1 and B2, with mode +B1−B2+, so that the poles that are created match those of the two permanent magnets 7a, 7b. Even in this case, the permanent magnets, at the end of the previous cycle, are slightly displaced compared to the electromagnets. This determines between the various poles a quadruple thrust S-S-NN-NN S-S between poles of the same sign, and a triple attraction S-S-NN NN between poles of opposite sign, for the permanent magnets to the direction D1.

In the right part of FIG. 3a, the two permanent magnets 7a, 7b have reached the point of stability, in that the poles of opposite sign, S poles of the lower permanent magnet and N-N poles of the electromagnets B1 and B2 and N-N poles of the permanent magnets and the electromagnet B2, attract and line up having resulted in a shift s1.

Similarly to what has been already seen in FIGS. 2a-2h, at this point, FIG. 3b, the control unit suspends power-supply to the pair of electromagnets B1 and B2, and simultaneously biases the pair of electromagnets A1 and A2, with mode +A1−A2+, of the column A that cause the quadruple thrust and the triple attraction of the permanent magnets thereby causing the shift s2.

In FIG. 3c, 3d are indicated the successive displacements s3 to s4, and relative biasings, that occur with similar mode polarizing alternately upwards a pair of electromagnets of each of the columns A and B alternately.

FIG. 3d shows the last shift s4 that completes half of the cycle detected by sensor 21.

Similarly to what has been already seen in FIGS. 2a-2h the return cycle starts from FIG. 3e and completes in FIG. 3h detected by the sensor 22.

The latter double permanent magnet configuration shown in FIGS. 3a-3h allows obtaining a greater thrust-force and thus higher heads than the configuration with only one permanent magnet, shown in FIGS. 2a-2h.

According to the same principle, one may also use more than two stacked, adjacent permanent magnets.

At top of FIG. 4 there is represented the upper movable part of the electromagnetic linear motor, which drives the compressor, consisting of a single permanent magnet 7, the two pistons 9a, 11 a and the stem 8 on which they are fixed and, immediately below, the movable part in the case constituted by two permanent magnets 7a and 7b with axis W.

In the lower part of FIG. 4 on the left there is represented the single electromagnet 2 with core U in the shape of a U or C, with relative coil 3, the axis q of the straight segment 4, the polar expansions 5 with an arc-recessed apex 6, the overall distance R and the distance r between the poles. To the right, the hollow cylinder or tube 401, with axis W, fixing six columns A and B with axis Q, each consisting of five electromagnets stacked with a spacing Z, staggered from each other in pairs by the distance h.

Note that, in the case of six columns, the corresponding columns are arranged in a tripod fashion with respect to the axis W thereby privileging axial and non-eccentric thrusts during operation. In the case of four columns, the homologous columns will be facing each other as will be seen later.

For a continuous and reliable operation the compressor may preferably envisage the use of cooled oil for the simultaneous cooling of the electromagnets 2 and the compression cylinders 9b, 11b, as well as the lubrication of the stem 8 and the bearing bushes 15 within which the stem 8 slides.

With reference to FIGS. 5a-5c, there is shown respectively a front, above and perspective view of one embodiment of compressor according to the present invention.

In the abovementioned FIGS. 5a-5c there is shown an oil inlet 51 for the cooling and lubricating and the relative outlets 52, the four non-return delivery valves 10b, 12b, 13b and 14b, the second non-return inlet valve 12a (the other three not being visible in the figures), as well as an electrical connector 53 for the power supply of the electromagnets 2.

In FIG. 5d there is shown a sectional view, made along the plane A of FIG. 3b, in which there are visible:
the electromagnets 2 with the respective windings 3,
the chamber 100,
a first free gap 54 for the cooling oil of the electromagnets 2, an oil communication channel 55,
a second free gap 56 for the cooling and lubrication oil of the bushings 15 (symmetrically arranged) and of the stem 8,
a further oil communication channel 58 in communication with
a third gap 59 for the cooling the compression cylinders 9b and 11b in which the pistons 9a and 11a slide.

In FIGS. 6a and 6b an actuator is shown in two operation phases. The actuator comprises the linear motor described above, wherein, though, the compressor's pistons are replaced by an additional component 61 adapted for moving objects or mechanical members.

With reference to FIGS. 7a-7c, there is shown respectively a side, front and perspective view of an embodiment of an actuator with piston rod 8 and component 61.

With reference to FIGS. 8a-8d, the operation of a distribution valve for reciprocating engines driven by the linear motor is schematically shown, where two columns A and two columns B are constituted of a single electromagnet A1 and B1, and the movable part is represented by one permanent magnet 7.

In the example of FIG. 8a the control unit supplies two electromagnets A1, facing each other with respect to the axis W, by biasing them with the same polarity of the permanent magnet 7 while it biases the electromagnets B with polarity opposite to the permanent magnet 7, so that the N pole of the permanent magnet 7 aligns S-N-S with both poles S of the electromagnets A1 and B1. In the right part of FIG. 8a we see the new position of the permanent magnet determined by the displacement s1 and the consequent opening of the valve's head at position H1.

At this point, FIG. 8b, the control unit maintains the electromagnet A1 powered while inverting the biasing of the electromagnets B1. This entails a further downward displacement s1 of the permanent magnet with the new alignment S-N-S and the complete opening of the valve at position H2.

The closure occurs with a reversed biasing mode.

With this configuration, the biasing of the electromagnets differs from what is described for the compressor and actuator, showing that the power supply and biasing mode of the electromagnets is dependent upon the number of electromagnets and the offset h between the columns.

In FIGS. 9a-9d there is represented an embodiment of a distribution valve for reciprocating engines. In FIG. 9a the complete valve 90 is visible with the stem 8 and the mushroom head 81; in FIG. 9b the side view of the stator 91 with two columns A and two columns B, each constituted of an electromagnet 2 with winding 3, offset by the distance h. FIG. 9c is a perspective view of the same stator and FIG. 9d shows the movable part constituted of the permanent magnet 7 with the stem 8 and the mushroom valve 81.

With reference to FIGS. 10a-10d, the operation is schematically shown of a distribution valve for reciprocating engines driven by the linear motor, where the two columns A and the two columns B, offset by the distance h, are constituted respectively of two electromagnets which are spaced apart by the spacing Z, and the movable part is represented by a double permanent magnet 7a and 7b with mutually opposite poles S-S. In this case the offset distance h between the columns A and B is less than that used in the motor equipping the previously described compressor and actuator, while the spacing Z between the poles of adjacent electromagnets is greater.

In the example of FIG. 10a a control unit power-supplies two electromagnets A1 and A2 of the column A, opposite to each other relative to the axis W, by biasing them with mode +A1−, +A2− while the electromagnets of the two columns B are not power-supplied. The N poles of the permanent magnet attracted by the S poles of the electromagnets and the S poles attracted by the N poles determine the new position of the permanent magnet visible on the right of FIG. 10a with consequent displacement s1 and opening of the valve at position H1.

At this point, FIG. 10b, the control unit suspends the power supply of the columns A and supplies the electromagnets of the column B, opposite one another relative to the axis W, by biasing them in mode +B1−, +B2−. The poles of the permanent magnet align in the same way of FIG. 10a. This entails a further downward movement s2 and the complete opening of the valve head at position H2.

The closure, FIG. 10c, occurs by biasing again +A− the electromagnets A and subsequently +B− the electromagnets B of FIG. 10d until the complete closure of the valve.

Also in this case it is noted that the biasing mode of the electromagnets depends on the length of the columns A and B, the spacing Z between the poles of the electromagnets that constitute the columns, the offset h between columns A and B and the number and shape of the permanent magnetic component used. In the specific case of FIG. 10a the offset distance h between the columns and the spacing Z between the poles of the electromagnets are equal.

For the motor, in general:
the number of columns of electromagnets and/or in a column may vary; and/or
preferably, to a column of electromagnets corresponds in the stator a homologous column of electromagnets placed in a diametrically opposite position with respect to the axis W. If the columns are four: a column A is opposed to a column A and column B is opposed to a column B.

If the columns are six, three columns are to be placed in a tripod fashion each oriented towards the axis W and the same applies for the columns B, and so for more higher numbers of columns.

This way the central permanent magnet receives thrusts or attractions that compensate each other while not being subjected to eccentric but only concentric forces; and/or
with stators of appropriate size not only two columns A and B but more columns, all mutually offset, may be provided;
the longitudinal offset h, parallel to the axis W, between heterologous columns may vary based on design and operational requirements; and/or
the spacing Z between the poles of the electromagnets constituting the columns may vary depending on design and operational requirements; and/or
the central permanent magnetic component may be constituted of a single permanent magnet or by two or more permanent magnets adjacent to one another with poles of same sign; and/or
the central permanent magnetic component may be made from some permanent magnets adjacent to one another with poles of opposite sign spaced from each other; and/or
the two expansions 5 of an electromagnet are preferably identical; and/or
the radius of curvature 6 of the two expansions 5 is slightly greater than the diameter of the permanent magnet; and/or
the biasing of the electromagnets may depend on:

the shape of the core of the electromagnets, and in particular the distance r between the expansions 5,

the spacing Z between the polar expansions of the electromagnets which make up the columns;

the magnitude of the offset h between columns;

the length of the permanent magnet;

the fact that the permanent magnetic component is constituted of a single permanent magnet or consists of several magnets stacked with opposed poles or with alternating poles in such case spaced;
application needs, and all the listed components may vary.

1. Electromagnetic linear motor comprising:
a tubular stator (1) having a longitudinal axis (W); and
a rectilinear stem (8) on which there is keyed a permanently magnetized component (7, 7a-7b) linearly movable along the axis inside the stator (1),
the stator (1) comprising at least two columns (A, B) formed by electromagnets (2),
each electromagnet (2) comprising a ferromagnetic (U) core comprising a central straight segment (4), with an axis (q), wound by a winding (3) and two polar expansions (5) arranged at the ends of—and orthogonal to—the central straight segment (4), said polar expansions (5) being oriented towards the—and orthogonally to—said axis (W),
each electromagnet (2) being arranged by aligning the central segment (4) and said axis (q) to form columns (A, B) having their axis (Q) parallel to the longitudinal axis (W), and arranged so that in each column the polar expansion (5) of an electromagnet (2) is aligned, and spaced by a spacing (Z), with respect to the polar expansion (5) of an adjacent electromagnet of the same column,
wherein the columns are
circularly arranged around said component (7,7a-7b), and
mutually offset along the longitudinal axis (W) by a distance (h), so that the electromagnets (2) of a column (A) are arranged offset parallel to the longitudinal axis (W) by a distance (h) with respect to the electromagnets (2) of another column (B).

2. Motor according to claim 1, comprising external power-supply means for windings (3) of the electromagnets of each column (A, B), the means being arranged to power-supply the windings (3) and bias in sequence, simultaneously or alternatively, electromagnets (2) of the columns (A, B) so as to force the said component (7,7a-7b) to displacements in one direction and subsequently in the opposite direction, so as to determine the reciprocating linear movement along the longitudinal axis (W) of said component and of said rectilinear stem (8).

3. Motor according to claim 1, wherein the magnetized permanently component (7) consists of a single permanent magnet or by two (7a-7b) or more permanent magnets stacked along said axis by setting near the respective poles of same polarity or setting near the respective poles of different polarity spaced from each other.

4. Motor according to claim 1, comprising a plurality of columns of electromagnets as defined above,
wherein the columns of the plurality of columns are divided into subgroups in which:
the electromagnets of the columns belonging to each subgroup are arranged parallel to the longitudinal axis (W) and in same positions,
the columns belonging to each subgroup are arranged around the longitudinal axis (W) with polar symmetry with respect to the same axis, and
columns of different subgroups are offset from each other by a distance (h) parallelly to the longitudinal axis (W) with respect to other subgroups.

5. Motor according to claim 1, wherein said distance (h) is less than the distance (R) measured between the ends of the poles (5) of the electromagnets (2) which constitute the columns.

6. Motor according to claim 1, comprising a magnetic or photoelectric detector (21,22) for detecting a limit stroke inside the stator of the permanently magnetized component.

7. Motor according to claim 1, wherein the ferromagnetic cores that make up the electromagnets (2) are U-shaped cores or C-shaped cores or horseshoe-shaped cores.

8. Motor according to claim 1, wherein each polar expansion of each electromagnet (2) comprises at the ends thereof arcuate recesses (6) whose curvature is substantially complementary to that of the permanent magnetic component (7, 7a-7b).

9. Compressor comprising a motor according to claim 1, wherein to the stem (8) are applied one or two symmetrical plungers (9a, 9b) adapted to compress fluids within one or two cylinders (11a, 11b).

10. Linear actuator comprising a motor according to claim 1, wherein the stem (8) is adapted to move objects or to which one (61) or two symmetrical components suitable for actuating devices are applied.

11. Electronically-controlled distribution valve for reciprocating engines comprising a motor according to claim 1, wherein the stem (8) is constituted of a distribution valve for reciprocating engine with mushroom-shaped shutter (81)
